(19) United States
(12) Patent Application Publication
(10) Pub. No.: US 2004/0068651 A1
(43) Pub. Date: Apr. 8, 2004

(54) Optical device for identifying friends and foes using real-time optical encryption and method for producing the same

(76) Inventor: Michael J. Pender, Arlington, VA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/470,386

(22) PCT Filed: May 21, 2002
(86) PCT No.: PCT/US02/15949

(51) Int. Cl. H04L 9/00

(52) U.S. Cl. 713/168

(57) ABSTRACT

An optical device (2100) may be configured to facilitate cooperative friend-or-foe target identification. The optical device (2100) may include at least one optical port (2120) configured to receive one or more optical signals from a source. The optical device (2100) may further include a plurality of optical elements (2120, 2130, 2140) that interact with the received optical signal to selectively radiate one or more optical signals (2110) based on information encoded within each received optical signal.

### CROSS-REFERENCE TO RELATED APPLICATIONS

This application claims the benefit of Patent Cooperation Treaty Application No. PCT/IB01/00888, entitled “OPTICAL MATRIX PHOTONIC LOGIC DEVICE AND METHOD FOR PRODUCING THE SAME” and filed on May 21, 2001, the entire contents of which are expressly incorporated herein by reference.

### FIELD OF THE INVENTION

The invention relates generally to optical devices having logic for processing optical signals, including smart optical switch devices, optical logic circuits, optical signal processors, and optical communications equipment. The invention relates more specifically to an optical device for identifying friendly troops in a military engagement scenario.

### BACKGROUND OF THE INVENTION

During a war, friendly troops may be mistakenly targeted and killed due to the inherent difficulty in identifying hostile combatants in a war-time environment. Increasingly, laser guidance systems have been used to designate targets because they allow a combatant to designate a target without revealing the combatant's position. This compares favorably against omni-directional radio Identification Friend-or-Foe (IFF) systems that may reveal the position of the combatant or the position of friendly troops to enemy forces.

Previous attempts to address this need have suffered from numerous deficiencies. For example, U.S. Pat. No. 4,361,911, entitled “Laser Retroreflector System for Identification of Friend or Foe” to Buser et al. requires a complex electro-optical receiver to detect a first coded signal from a combatant's laser interrogator and an electro-acoustic mirror assembly to transmit a second coded signal from the target to the combatant. However, maintaining complex electro-optical devices is very difficult in a battlefield environment, and failure to detect the transmitted signal and properly respond may result in the deaths of friendly troops. Moreover, systems such as Buser always transmit the same reply signal and thus are subject to replication by a sophisticated enemy. Furthermore, the Buser system may fail to operate properly when interrogated by more than one combatant simultaneously because the interrogation signal may be corrupted.

Traditional devices for processing high frequency signals typically include multiple stages. For example, a communications device may include an antenna, coupled to a receiver, including bandpass filter to select a frequency band of interest, and hardware that downconverts the frequency of interest, coupled in turn to a device for decrypting the received signal. Consequently, to address the limitations of previous target identification systems, a need exists for integrated optical devices that combine various components such as the receiver, bandpass filter, and decryption processor into a single device.

In addition, optical logic devices are a first step in the miniaturization of photonic devices and a critical missing link in building an all-optical Internet. The transmission of high frequency signals by electrical cabling incurs a significant power loss compared to using fiber optic cabling. Transmitting a 100 MHz signal across a 1.0 km distance using a typical electrical cable incurs a signal power loss nearly a thousand times larger than transmitting the same signal over a single mode fiber optic cable at optical carrier wavelengths. Consequently, fiber optic signal cables are preferred when transmitting signals over long distances. A significant difficulty with constructing wide-area networks using fiber optic cables is that routing optical information requires converting photonic signals into electrical signals for analysis by electronic switches, followed by conversion back into photonic signals for retransmission.

One of the first critical applications for photonic switches will be to eliminate electronic switching in fiber-optic Internet backbones. As photonic signals become increasingly complex, the bandwidth of electronic switches may become insufficient. In response to this need, several companies have developed prototype electro-optical switches to better meet the demand for bandwidth. However, even though electro-optical switches can redirect photonic signals, the switches are unable to interpret the data encoded within the photonic signals. Thus, electronic switches are still needed to interpret the data packets contained within the photonic signals to route the packets. Therefore, there is a need for a photonic logic device with the speed of optics and the intelligence of microelectronics to interpret photonic signals. Various approaches have been suggested for integrating microelectronics and photonic circuitry within a chip, such as by creating photonic wiring between transistors. However, the continued use of electronics would impose several significant limitations.

First, the operating speed of an electronic computer is limited by delays in redistributing information around the processor chip. A transistor is a trans-resistive device in which a change of state is effected by adjusting a variable resistance, causing a memory capacitor to charge or discharge. The delays are primarily due to resistive and capacitive effects that do not decrease as electronic circuitry is scaled down in size; rather, the delays generally increase, as noted in Richard Turton's The Quantum Dot: A Journey into the Future of Microelectronics, p. 174. Unlike electronic signals, photonic signals do not suffer from capacitive or resistive effects. In contrast, an optical matrix device may change logical state in the time it takes for photons to propagate across the matrix. Photons travel at a speed approximately a hundred times faster than electrical signals. Thus, it would be preferable to implement logic devices with optical matrices instead of electronic switches and Einstein's theory of relativity states that a photonic signal is the fastest way to communicate information from one point to another.

Second, electronic devices are highly susceptible to environmental conditions. Electronic devices may be damaged by over-voltage conditions, brownouts or blackouts, and may latch-up if operated in an under-voltage condition. Electronic devices may be destroyed by electrostatic discharges if mishandled. Additionally, a lightning strike in the vicinity of a cable connected to an electronic computer network may endanger the entire network. Also, electronic devices are sensitive to interference, such as intermodulation, intersymbol interference and electromagnetic interference generated by radio stations, cellular telephone towers, high-tension power lines, and other electronic devices. Electronic devices are also susceptible to damage by ionizing radiation, such as the radiation produced by solar flares and the North Atlantic Anomaly. Therefore, electronic devices used for communication networks must be thoroughly shielded against adverse environmental conditions, such as electromagnetic interference and ionizing radiation. In contrast, optical devices are essentially immune to electromagnetic interference and ionizing radiation. Consequently, optical matrix devices are preferred over electronic devices for use in adverse environmental conditions.

Finally, electronic devices generate heat from the friction that results when electrons interact with each other. Electronic devices must be cooled to maintain the devices in working order. There are three primary modes by which thermal energy may be transferred: conduction, convection, and radiation. Thermal design imposes significant constraints on electronic devices intended for use in spacecraft because only the radiation transfer mode is available. Thus, thermal design is a critical factor for spacecraft applications, significantly affecting the size, weight, power requirements and service lifetime of spacecraft. In contrast, photons do not interact with each other under most circumstances and thus need not produce heat from friction. Consequently, optical matrix devices are preferable for temperature-constrained applications, such as space vehicles and communications satellites.

Therefore, there is a need for a photonic logic device that may be configured as a smart photonic switch to enable an all-optical Internet. Additionally, photonic logic devices are desirable for avoiding many of the limitations of electronic computer networks, including signal attenuation and environmental sensitivity. Furthermore, smart photonic switches eliminate many of the risk factors that degrade reliability of electronic computer networks. Optical matrix switches may enjoy many advantages over traditional electronic and electro-optical switches. First, optical matrix switches may be significantly faster than transistor-based switches. Second, optical matrices may be constructed using materials such as non-conductive glass fibers that are highly resistant to environmental conditions including temperature, humidity and electric shock. Additionally, glass materials do not couple electrical signals from the external environment, such as radio stations, cellular telephone towers, high-tension power lines, and electronic devices. Thus, optical devices require minimal shielding against environmental conditions. Finally, optical devices generally do not require temperature regulation. In general, photons do not interact with each other and therefore do not generate the heat that results from friction when electrons interact with each other. Thus, optical devices typically do not generate significant heat and do not require supplemental cooling. For at least these reasons, optical matrix devices are a desirable replacement for transistors.

### BRIEF SUMMARY OF THE INVENTION

Optical matrices consistent with the present invention may be configured to implement a photonic logic device, such as a smart photonic switch, that overcomes many limitations and deficiencies of the prior art. Prior-art electro-optic switches are unable to interpret and respond to data encoded within a photonic signal. The photonic signal must first be converted to an electrical signal and interpreted by transistor-based electronic circuits. In the present invention, an optical matrix may be configured as a photonic logic device, such as a smart photonic switch that interprets and responds to data encoded within the photonic signal and routes the photonic signal accordingly. An optical matrix may implement a logic function by configuring optical elements in the matrix to produce an interference pattern corresponding to the logic function. An optical matrix may generate one or more output signals by combining the energy of one or more input signals; consequently, an optical matrix may switch photonic signals without consuming energy in the process. When properly configured, an optical matrix may implement signal processing functions such as cosine transforms, or logic functions such as the Boolean logic functions used in electronic computers. Moreover, optical devices consistent with the present invention may integrate the equivalent of multiple devices such as, for example, a receiver, a signal processor, logic, an encryptor, and a transmitter into a single optical device. Thus, a single optical device consistent with the present invention may be used to identify friendly troops.

A device for cooperative friend-or-foe target identification consistent with one aspect of the present invention may comprise at least one optical port configured to receive at least one optical signal from a source; a plurality of optical elements that interact with the received optical signal based on information encoded within said at least one optical signal to selectively radiate a second optical signal.

A device for real-time encryption consistent with another aspect of the present invention may comprise at least one optical port configured to receive at least one optical signal from a source; and a plurality of optical elements that interact with the received optical signal to determine a second optical signal by encrypting the received optical signal according to a predetermined cryptographic algorithm.

Methods and systems for cooperative friend-or-foe target identification consistent with one aspect of the present invention may comprise means for receiving at least one optical signal from a source; means for determining, using a plurality of optical elements, whether to radiate a second optical signal based on information encoded within said at least one optical signal; and means for selectively radiating the second optical signal based upon the determination.

Methods and systems for real-time encryption consistent with another aspect of the present invention may comprise means for receiving at least one optical signal from a source; and means for determining a second optical signal, using a plurality of optical elements that encrypt the received optical signal according to a predetermined cryptographic algorithm.

A computer program product consistent with one aspect of the present invention may comprise a computer usable medium having a computer readable program code means embodied in said medium for configuring an optical device to determine, using a plurality of optical elements, whether to radiate a second optical signal based on information encoded within at least one received optical signal and to selectively radiate the second optical signal based upon the determination.

A computer program product consistent with another aspect of the present invention may comprise a computer usable medium having a computer readable program code means embodied in said medium for configuring an optical device to determine, using a plurality of optical elements, whether to radiate a second optical signal based on information encoded within at least one received optical signal and to selectively radiate the second optical signal based upon the determination.

### BRIEF DESCRIPTION OF DRAWINGS

FIG. 1 shows an exemplary optical matrix that may be configured as a photonic logic device, such as a smart photonic switch;

FIG. 2 shows a complete set of Boolean mapping functions that associate two input values to output values;

FIG. 3 shows several sets of Boolean functions with an exemplary implementation of each Boolean function using Boolean primitives;

FIG. 4 shows an exemplary amplitude envelope that may result when adding two phasors that have approximately equal magnitude and a relative phase difference;

FIG. 5 shows an exemplary flowchart for configuring an optical matrix as a photonic logic device, such as a smart photonic switch;

FIG. 6 shows an exemplary flowchart for selecting a configuration of optical elements to implement a desired photonic logic device using the optical matrix;

FIG. 7 illustrates an exemplary evolution strategy for generating a successive generation of configurations of optical elements to implement a desired photonic logic device;

FIG. 8 shows exemplary optical matrices configured to implement a photonic XOR logic gate and a photonic OR logic gate;

FIG. 9 shows an exemplary physical system that may be modeled using the present invention;

FIG. 10 shows an exemplary state model analogous to the physical system;

FIG. 11 shows an exemplary cube representing a physical segment of an optical channel;

FIG. 12 shows a cut-away drawing of a segment of an optical channel;

FIG. 13 shows the Cartesian coordinates, azimuth and elevation of each vertex of the cube and distances between faces of the cube;

FIG. 14 shows the cube superimposed upon a sphere with the geometric center of one face at the center of the sphere and vertices of the cube tangent to the surface of the sphere;

FIG. 15 shows an exemplary state model representative of a photon transfer process within a segment, representative of the present invention;

FIG. 16 shows exemplary Feynman diagrams representing interactions between photons and electrons;

FIG. 17 shows exemplary Feynman diagrams in which electrons traverse different paths from the same initial positions to the same final positions;

FIG. 18 shows an exemplary transition matrix for a cubic segment of an optical channel;

FIG. 19 shows a method for determining an optical signal at a segment corresponding to the exemplary physical system shown in FIG. 9 and the exemplary state model shown in FIG. 10;

FIG. 20 shows a method for determining an optical signal at a face of the segment corresponding to the physical segment shown in FIG. 11;

FIG. 21 shows an exemplary optical device configured to provide cooperative battlefield identification of friendly forces.

### DETAILED DESCRIPTION

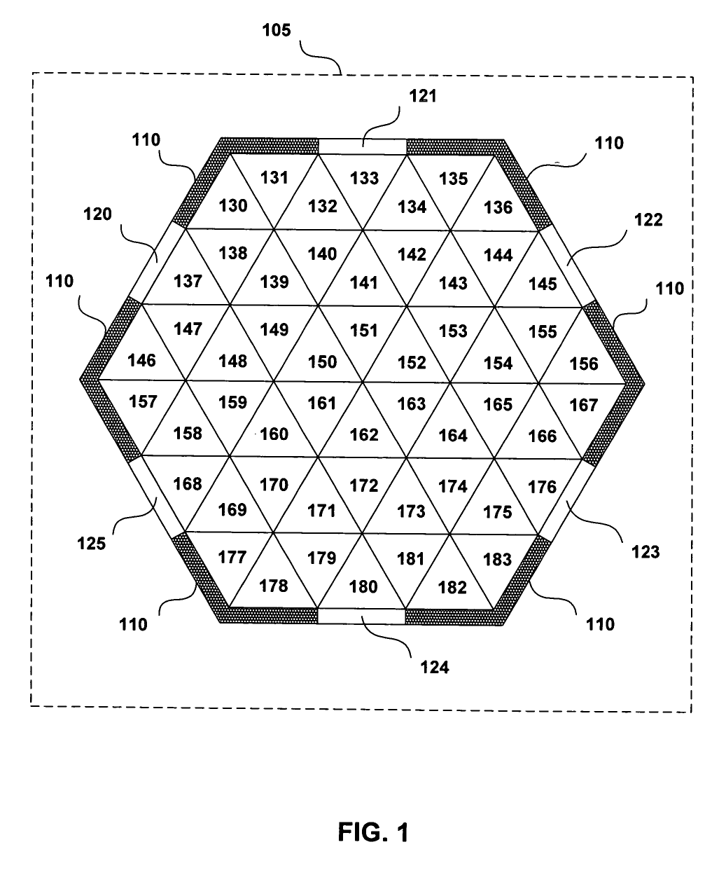

FIG. 1 shows an exemplary optical matrix 105 that may be configured as a photonic logic device, such as a smart photonic switch. The optical matrix 105 may include cladding material 110 that constrains light within an enclosed space. The optical matrix 105 may also include optical ports 120 to 125 that allow photonic signals to enter and exit the optical matrix 105 through the cladding material 110. The interior of the optical matrix 105 may be partitioned into optical elements 130 to 183 that transmit, absorb, diffract, reflect and/or refract light within the optical matrix 105. The optical matrix 105 may have a hexagonal topology, a square topology, a rhomboid topology, a triangular topology, an elliptic topology, or a topology that is not a regular geometric shape. Similarly, each element of the optical matrix 105 may be triangular, square or elliptic, and is not necessarily a regular geometric shape. The optical matrix 105 topology and shape of an element of the optical matrix 105 are only limited by the process used to map a configuration to an implementation, such as sub-micron lithography. Consequently, an optical matrix 105 may be a three-dimensional structure comprising multiple layers of optical material. Similarly, each element of the optical matrix 105 may be a three-dimensional structure such as, for example, a sphere or a cylinder. In a preferred embodiment, the optical elements 130 to 183 may be smaller in linear dimension than a wavelength λ′ of a photonic signal of interest in the material of the optical matrix 105, such that an area of size λ′×λ′ may include surfaces of nine or more elements. A photon may enter the optical matrix 105 through one of the optical ports 120 to 125. The photon may then traverse a path through the optical elements 130 to 183 until the photon exits through one of the optical ports 120 to 125. Individual photons may traverse chaotic paths through the optical matrix 105 that are difficult to predict. However, when a plurality of photons traverse the optical matrix 105, each configuration of optical elements 130 to 183 produces a predictable interference pattern among the photons.

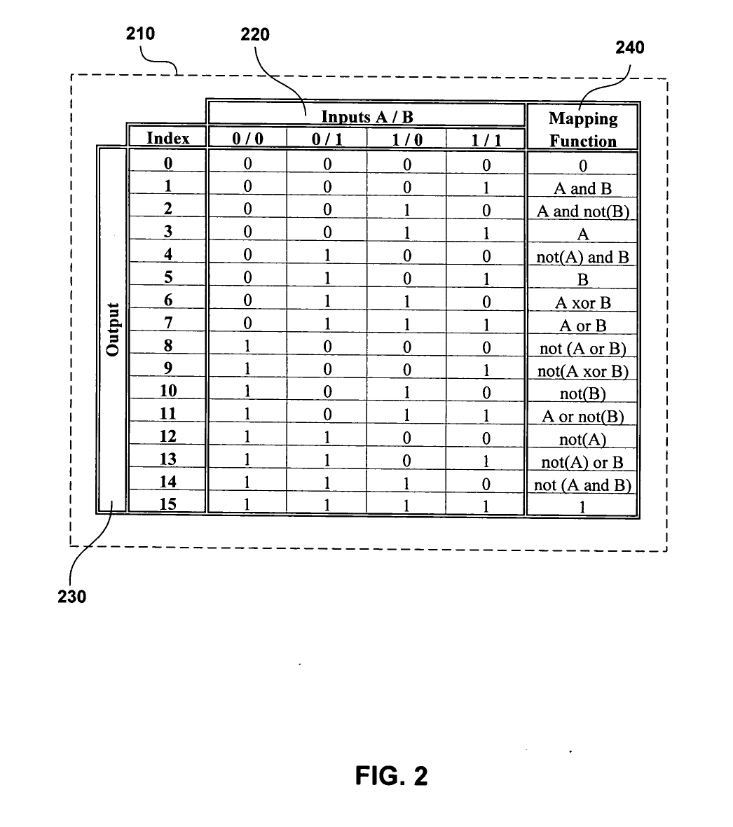

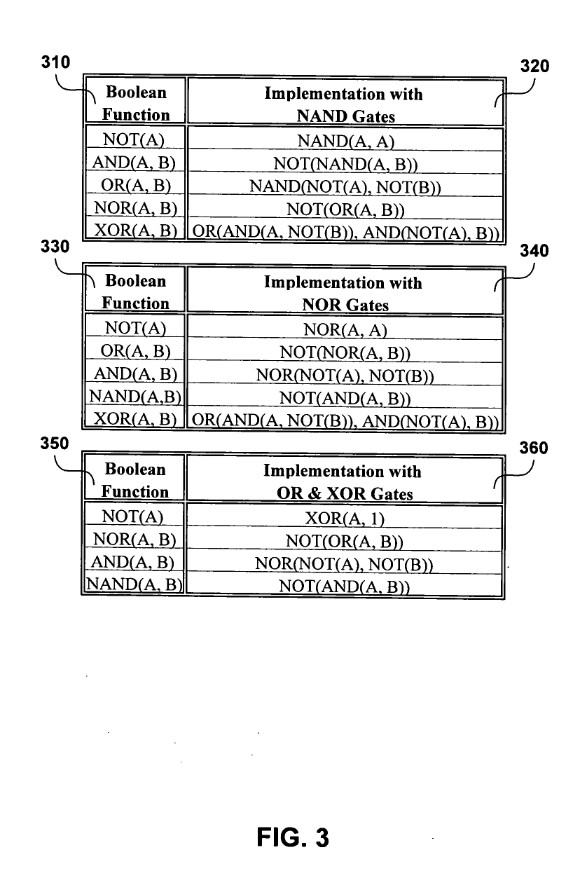

In electronic computers, logic functions may be implemented using Boolean gates. FIG. 2 shows the complete set 210 of Boolean mapping functions 240 that associate two input values A and B 220 to a set of output values 230. The Boolean mapping functions 240 are described using several Boolean operators selected from a set including AND, OR, NOT, NAND, NOR, and XOR operators. All Boolean functions may be implemented using a set of Boolean primitives, such as NAND gates or NOR gates. FIG. 3 shows several sets of Boolean functions, along with an exemplary implementation of each Boolean function using Boolean primitives. For example, each of the Boolean functions 310 including NOT, AND, OR, NOR and XOR is shown with a respective implementation 320 of the Boolean function 310 using NAND gates. Therefore any Boolean function may be implemented using only NAND gates. Also, each of the Boolean functions 330 including NOT, OR, AND, NAND and XOR is shown with a respective implementation 340 of the Boolean function 330 using NOR gates. Therefore any Boolean function may be implemented using only NOR gates. Finally, each of the Boolean functions 350 including NOT, NOR, AND and NAND is shown with a respective implementation 360 using OR and XOR gates. Therefore any Boolean function may be implemented using only OR and XOR gates.

Because any Boolean function may be implemented using only OR and XOR gates, any Boolean function may be implemented using a properly configured optical matrix 105. A first photonic signal A may be represented with the phasor equation:

A=|A|·e^{jax}

And a second photonic signal B may be represented with the phasor equation:

B=|B|·e^{j(ax+θ)}

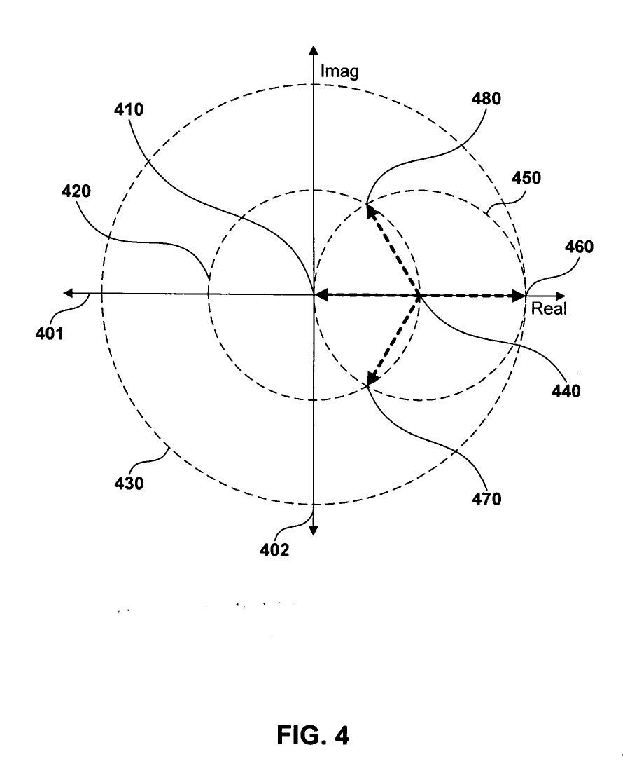

FIG. 4 shows an exemplary amplitude envelope that may result when the phasors are approximately equal in magnitude with a relative phase difference of θ radians. For example, a real axis 401 and an imaginary axis 402 intersect at a first origin 410 of a first circle 420 having magnitude of one unit, and a second circle 430 having magnitude of two units. A unit vector projects from the origin 410 along the real axis 401 to a second origin 440 of a third circle 450 having magnitude of one unit. When the signals are completely in-phase, then the signals interfere constructively and the sum of the vectors 460 has a magnitude of two units, i.e.:

θ=2πn, where n is an integer→|A+B|=2

When the signals are completely out-of-phase, then the signals interfere destructively and the sum of the vectors 410 has a zero magnitude, i.e.:

θ=2πn±π, where n is an integers→|A+B|=0

When the first circle 420 and the third circle 450 intersect, then the sum of the vectors 470 and 480 has a unit magnitude, i.e.:

θ=2πn±2π/3, where n is an integer→|A+B|=1

Consequently, the phase difference between the first signal and the second signal may be used to determine an interference pattern produced by the photonic signals.

The optical matrix 105 may implement a particular Boolean logic function by configuring the optical elements 130 to 183 to produce a phase difference between the optical ports 120 to 125. First, a phase-modulated photonic input signal A may be coupled to optical port 120 and a phase-modulated photonic input signal B may be coupled to optical port 121. A phase-modulated signal having a phase offset of zero radians may represent a Boolean “0” state and a phase offset of π radians may represent a Boolean “1” state. Second, unused optical ports 122 and 125 may be cladded to produce total internal reflection. Third, the amplitude-modulated result of the function may be sensed at optical port 123. A signal amplitude of zero, i.e. no signal, may correspond to a Boolean “0” state and a non-zero signal amplitude may correspond to a Boolean “1” state. Finally, optical port 124 may be coupled to an optical terminator (not shown).

For example, a photonic XOR gate may be implemented by configuring the optical elements 130 to 183 of the optical matrix 105. Four possible outputs are shown in Row 6 of FIG. 2 from the set 210 of Boolean functions; each output corresponds to one of four combinations of the two Boolean input signals, A and B:

1. if input A=0 and input B=0, then ƒ(A, B)=0;

2. if input A=0 and input B=1, then ƒ(A, B)=1;

3. if input A=1 and input B=0, then ƒ(A, B)=1;

4. if input A=1 and input B=1, then ƒ(A, B)=0.

Each “input” may be represented by a phasor and each “output” may be represented by an amplitude, producing the following set of simultaneous equations:

$$\begin{matrix}1. \vert f ( \vert A \vert \cdot {ⅇ}^{j ω t} , \vert B \vert \cdot {ⅇ}^{j ω t} ) \vert = \frac{\vert A \vert - \vert B \vert}{2} & \\ 2. \vert f ( \vert A \vert \cdot {ⅇ}^{j ω t} , \vert B \vert \cdot {ⅇ}^{j ( ω t + π )} ) \vert = \frac{\vert A \vert + \vert B \vert}{2} & \\ 3. \vert f ( \vert A \vert \cdot {ⅇ}^{j ( ω t + π )} , \vert B \vert \cdot {ⅇ}^{j ω t} ) \vert = \frac{\vert A \vert + \vert B \vert}{2} & \\ 4. \vert f ( \vert A \vert \cdot {ⅇ}^{j ( ω t + π )} , \vert B \vert \cdot {ⅇ}^{j ( ω t + π )} ) \vert = \frac{\vert A \vert - \vert B \vert}{2} & \end{matrix}$$

One solution to this set of equations is the mapping function:

$$f ( A , B ) = \frac{1}{2} ( A + B \cdot {ⅇ}^{j ( 2 π n \pm π )} ) ,$$

where n is an integer.

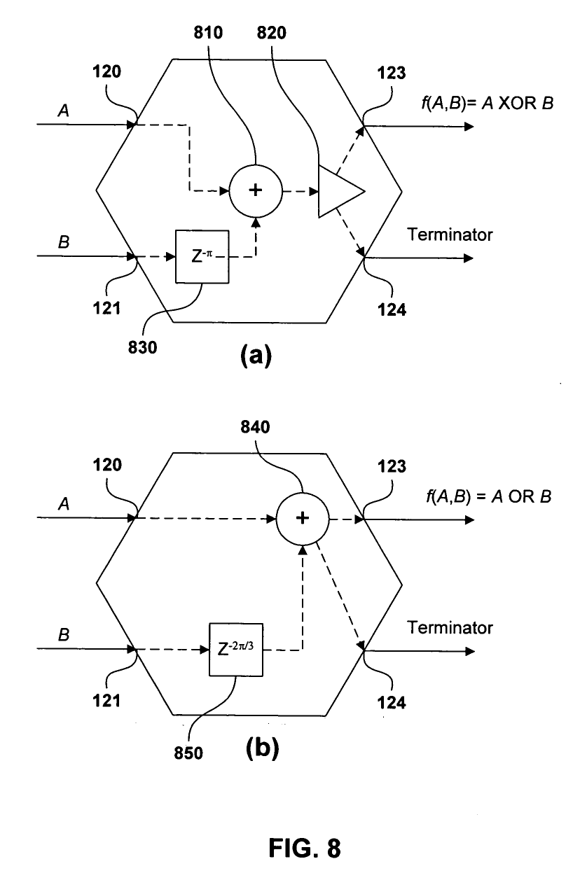

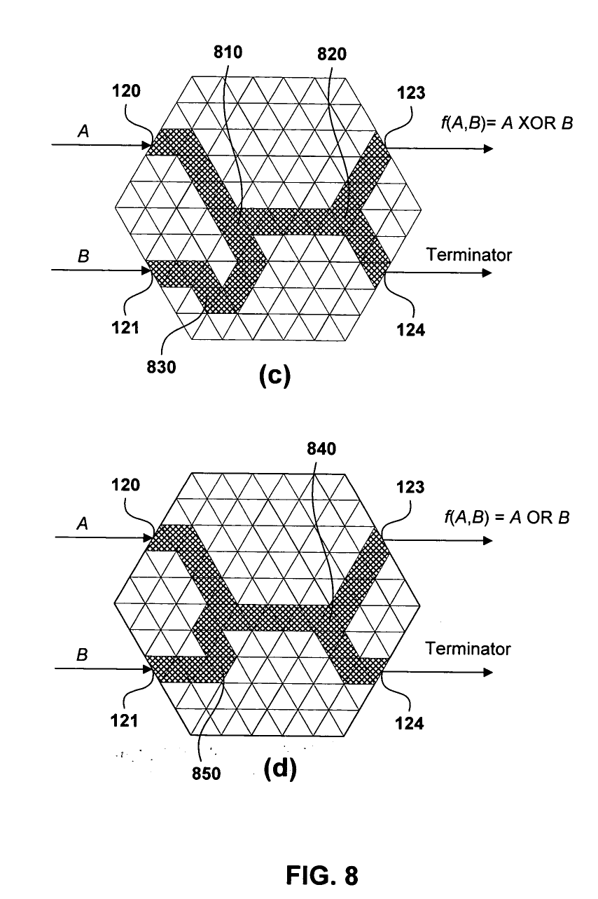

FIG. 8(a) shows an exemplary photonic XOR gate that implements this mapping function. The XOR gate includes an adder 810 that combines the input photonic signals from input optical ports 120 and 121. The adder 810 is coupled to a splitter 820 that divides the power of the signal from the adder, routing half of the signal to output optical port 123 and half of the signal to optical terminator port 124. The phase difference of π radians may be produced using different path lengths 830 between the input optical ports 120 and 121, and the adder 810. The phase shift produced by a difference in path length Δd may be determined using the equation:

$$Δ θ = \frac{2 π \cdot Δ d}{{λ}^{′}} ,$$

where λ′ is the wavelength of the photonic signal in the material of the optical matrix 105. FIG. 8(c) shows an exemplary optical matrix 105 configured to implement the photonic XOR gate.

Similarly, a photonic OR gate may be implemented by configuring the optical elements 130 to 183 of the optical matrix 105. Four possible outputs are shown in Row 7 of FIG. 2 from the set 210 of Boolean functions; each output corresponds to one of four combinations of the two Boolean input signals, A and B:

1. if input A=0 and input B=0, then ƒ(A, B)=0;

2. if input A=0 and input B=1, then ƒ(A, B)=1;

3. if input A=1 and input B=0, then ƒ(A, B)=1;

4. if input A=1 and input B=1, then ƒ(A, B)=1.

Each “input” may be represented by a phasor and each “output” may be represented by an amplitude, producing the following set of simultaneous equations:

$$\begin{matrix}1. \vert f ( \vert A \vert \cdot {ⅇ}^{j ω t} , \vert B \vert \cdot {ⅇ}^{j ω t} ) \vert = \frac{\vert A \vert - \vert B \vert}{2} & \\ 2. \vert f ( \vert A \vert \cdot {ⅇ}^{j ω t} , \vert B \vert \cdot {ⅇ}^{j ( ω t + π )} ) \vert = \frac{\vert A \vert + \vert B \vert}{2} & \\ 3. \vert f ( \vert A \vert \cdot {ⅇ}^{j ( ω t + π )} , \vert B \vert \cdot {ⅇ}^{j ω t} ) \vert = \frac{\vert A \vert + \vert B \vert}{2} & \\ 4. \vert f ( \vert A \vert \cdot {ⅇ}^{j ( ω t + π )} , \vert B \vert \cdot {ⅇ}^{j ( ω t + π )} ) \vert = \frac{\vert A \vert + \vert B \vert}{2} & \end{matrix}$$

One solution to this set of equations is the mapping function:

$$f ( A , B ) = ( A + B \cdot {ⅇ}^{j ( 2 π n \pm \frac{2 π}{3} )} ) ,$$

where n is an integer.

FIG. 8(b) shows an exemplary photonic OR gate that implements this mapping function. The OR gate includes an adder 840 that combines the input photonic signals from input optical ports 120 and 121. The adder 840 is coupled to output optical port 123 and to optical terminator port 124. The phase difference of ±2π/3 radians may be produced using different path lengths 850 between the input optical ports 120 and 121 and the adder 840. Any Boolean function 350 may be implemented 360 by coupling the OR and XOR gates, as discussed previously with regard to FIG. 3. FIG. 8(d) shows an exemplary optical matrix 105 configured to implement the photonic OR gate.

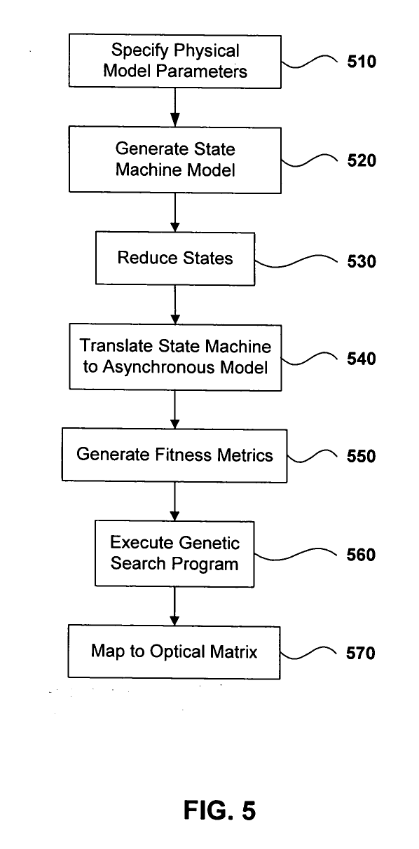

However, an optical matrix 105 may also be configured to generate an interference pattern that corresponds to any Boolean function 350 by properly configuring the optical elements 130 to 183. FIG. 5 shows an exemplary flowchart for configuring an optical matrix 105 as a photonic logic device. First, a user may specify physical model parameters for an implementation (step 510). For example, the user may specify one or more wavelengths of interest. The user may also specify a transmission factor, an absorption factor, a reflectivity factor, a refractive index and a speed of light in the medium of the optical matrix 105 for the one or more wavelengths of interest. The user may further specify an optical matrix 105 topology, such as the hexagonal topology of FIG. 1. Then the user may generate a state machine model that represents the physical implementation (step 520). Next, the state machine model may be simplified by eliminating unused, equivalent, and redundant states (step 530) by methods such as those taught by Charles H. Roth, Jr. in Fundamentals of Logic Design, “Chapter 15—Reduction of State Tables & State Assignment” (1995). The sequential state machine model may also be translated into an asynchronous state model (step 540) by methods such as those taught in Roth's “Chapter 23—Analysis of Asynchronous Sequential Networks.” Then, the user may generate fitness metrics for a genetic search program (step 550) and execute the genetic program (step 560) to determine a “best” configuration for configuring the optical matrix 105 as a photonic logic device. Finally, the best configuration may be mapped for implementation in the optical matrix 105 (step 570) using masking techniques such as bitmap, raster or block-transfer graphics.

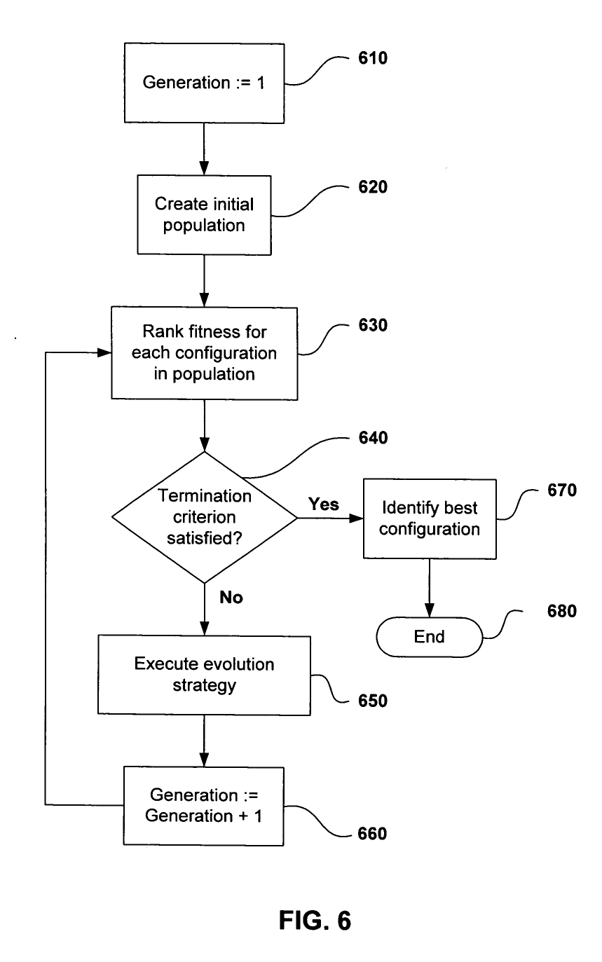

A genetic program may be used to determine the best possible configuration of the optical elements 130 to 183 of the optical matrix 105 to implement a particular logic function. FIG. 6 shows an exemplary flowchart for selecting a configuration of optical elements 130 to 183 to implement a desired logic function using the optical matrix 105. First, a counter variable is initialized to track the number of generations (step 610). Next, an initial population of possible configurations of the optical elements 130 to 183 is generated (step 620). Each configuration may be a software object comprising a “chromosome” field containing “alleles” that represent the configuration of each element in the optical matrix 105, an “evaluated” field that indicates whether the configuration has been evaluated with a fitness metric, and a “fitness” field that indicates the result of applying the fitness metric to the configuration. Each “allele” may also be a software object comprising information about how each element transmits, absorbs, diffracts, reflects and refracts a photonic signal at the one or more optical wavelengths of interest. The “evaluated” field may be used to avoid repeatedly evaluating the fitness of the same configuration, thereby reducing the computational effort required to evaluate a population as compared to traditional genetic programs.

Then a fitness metric is applied to each configuration in the population and the configurations are ranked in order from most fit to least fit (step 630). The ranked population may be evaluated to determine whether a specified termination criterion is satisfied (step 640), such as by finding a perfect solution to the fitness metric or by exceeding a specified number of generations. If the termination condition is not satisfied, an evolution strategy may be executed to generate the next generation of the population (step 650). Finally, the generation counter variable is incremented (step 660) and the new population is ranked in order from most fit to least fit (step 630). The search process repeats until one or more termination criteria are satisfied (step 640). Then the best configuration of optical elements 130 to 183 is identified (step 670) and the genetic program terminates (step 680).

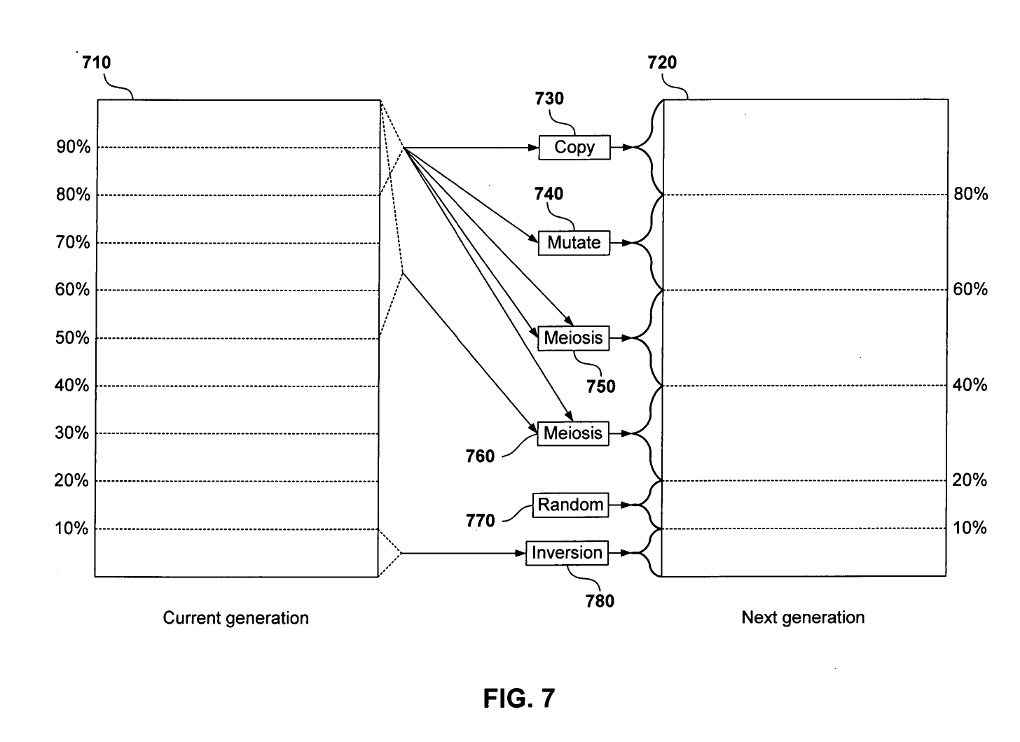

The process of generating desirable configurations may be guided using an evolution strategy. FIG. 7 illustrates an exemplary evolution strategy for generating successive generations of configurations of optical elements 130 to 183 to implement the desired photonic logic device. The exemplary evolution strategy illustrates the use of five transition operators to map the population of configurations from a current generation 710 to a next generation 720.

First, a copy 730 operator may be used to copy configurations from the current generation 710 to the next generation 720. For example, the fittest 20% of the configurations in the current generation 710 may be copied to the next generation 720. The copy 730 operator may be used to ensure that the fittest individuals of the current generation 710 are included in the next generation 720, thereby eliminating the problem of “back-sliding” that occurs with traditional genetic programs.

Second, the mutate 740 operator may be used to invert one or more elements in each configuration. For example, each of the configurations in the fittest 20% of the current generation 710 may be mutated and inserted into the next generation 720. The mutate operator 740 may be used to prevent stagnation among the fittest members of the population by introducing limited diversity into the fittest configurations of the current generation 710, before inserting the configurations into the next generation 720.

Third, the meiosis 750 operator may be used to recombine configurations using one-point or two-point crossover. For example, each configuration in the fittest 20% of the current generation 710 may be recombined using a two-point crossover with another configuration selected at random from the fittest 20% of the current generation 710. Then the recombined configurations may be inserted into the next generation 720. The meiosis 760 operator may also select configurations from different sections of the current generation 710 to enhance diversity in the next generation 720. For example, each configuration in the fittest 20% of the current generation 710 may be recombined using a two-point crossover with another configuration selected at random from the fittest 50% of the current generation 710. Then the recombined configurations may be inserted in the next generation 720. The meiosis operator 750 may be used to generate “child” configurations for the next generation 720 using the fittest “parent” configurations of the current generation 710.

Fourth, the random 770 operator may be used to generate configurations for the next generation 720 that have elements selected at random, with no particular relationship to configurations of the current generation 710. For example, 10% of the next generation 720 may be generated with the random 770 operator. The random 770 operator may be used to prevent stagnation of the population.

Fifth, the inversion 780 operator may be used to invert all elements in a configuration of the current generation 710 before inserting the inverted configuration into the next generation 720. For example, the least fit 10% of the current generation 710 may be inverted and inserted into the next generation 720. The worst configurations of the current generation 710 may be converted into highly fit configurations for the next generation 720 by using the inversion operator 780 to invert optical elements that cause the configuration to be undesirable.

A genetic program may use a fitness function to evaluate each configuration of the optical matrix 105. A fitness function may comprise a weighted average of the error margins resulting from representing a desired logic function using a particular configuration of the elements 130 to 183 of the optical matrix 105. The interference pattern produced by a particular configuration of optical elements 130 to 183 may be determined by using a ray-tracing engine to determine the output of the optical matrix 105 in response to the four input conditions. For example, a particular configuration may produce the following set of responses:

1. |ƒ(|A|·e^{jax}, |B|·e^{jax})|=C

2. |ƒ(|A|·e^{jax}, |B|·e^{j(ax+π)})|=D

3. |ƒ(|A|·e^{j(ax+π)}, |B|·e^{jax})|=E

4. |ƒ(|A|·e^{j(ax+π)}, |B|·e^{j(ax+π)})|=F

The error terms for an XOR photonic gate are:

$$\begin{matrix}{ϵ}_{1} = \vert C - \frac{\vert A \vert - \vert B \vert}{2} \vert , & {ϵ}_{2} = \vert D - \frac{\vert A \vert + \vert B \vert}{2} \vert \\ {ϵ}_{3} = \vert E - \frac{\vert A \vert + \vert B \vert}{2} \vert , & {ϵ}_{4} = \vert F - \frac{\vert A \vert + \vert B \vert}{2} \vert\end{matrix}$$

The fitness function may be a function of the mean squared error terms, for example:

$$Fitness = 1 - \frac{{ϵ}_{1}^{2} + {ϵ}_{2}^{2} + {ϵ}_{3}^{2} + {ϵ}_{4}^{2}}{4 \cdot ( \vert A \vert + \vert B \vert )}$$

In the alternative, the fitness function may be a fuzzy logic function of the error terms, for example:

$$Fitness = 1 - \frac{2 \cdot max \{ {ϵ}_{1} , {ϵ}_{2} , {ϵ}_{3} , {ϵ}_{4} \}}{\vert A \vert + \vert B \vert}$$

The response of a particular configuration of optical elements 130 to 183 of the optical matrix 105 to input signals A and B may be determined by ray-tracing the path of photons through the optical matrix 105. However, traditional ray-tracing methods are sub-optimal for several reasons. First, traditional ray-tracing methods model photons by assuming that they behave as particles on definite paths. However, at scales approaching 1.0×10⁻¹⁰ meters the paths of photons are highly chaotic. Second, by modeling photons as particles, traditional ray-tracing methods fail to incorporate the phase properties that produce diffraction, polarization, refraction and reflection effects. Third, traditional ray-tracing methods model reflections by tracing the paths of photons through time. However, within an optical matrix 105, paths may exist that permit an infinite number of reflections. Thus, traditional ray-tracing models would be unable to determine the paths of the photons. In addition, traditional ray-tracing methods are notoriously slow and are intended to produce photo-realistic results, not engineering-quality results. A preferred method of modeling the paths of photons may use a technique based on probabilistic paths through 4-dimensional space and time, where each possible path has an associated probability that represents the likelihood that a photon will traverse the path. Hereinafter, the term “tessic” is used to refer to a path through 4-dimensional space and time that is associated with a probability of occurrence.

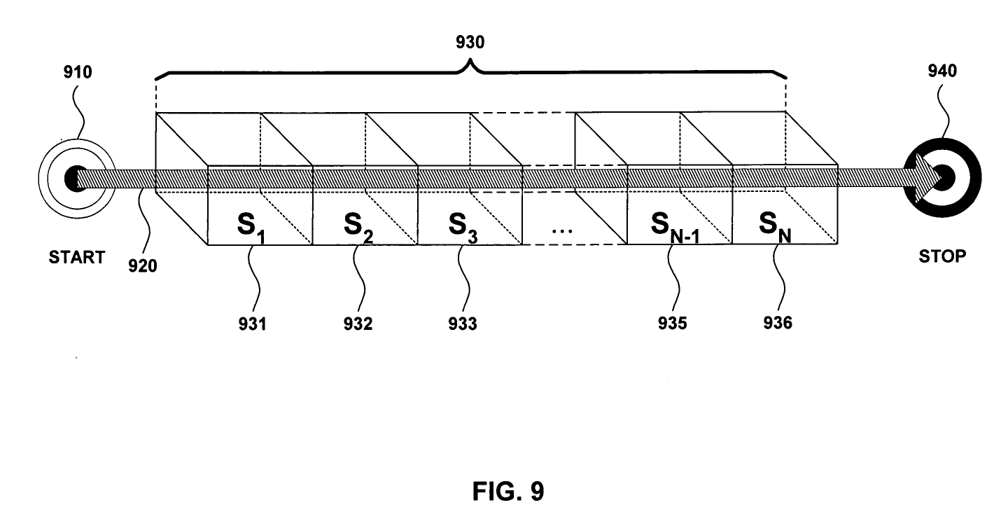

A tessic path-tracing system may be used to determine the response of a physical system to photonic signals. FIG. 9 shows an exemplary physical system that may be modeled using the present invention. The system may contain a light source 910, such as a laser emitter. The light source 910 may project a photonic signal 920 through an optical channel 930 and into an optical terminator 940. The optical channel 930 may be partitioned into N segments S₁ 931 to S_{N} 936, where S₁ 931 is the segment closest to the light source 910 and S_{N} 936 is the segment closest to the optical terminator 940. Photons produced by the light source 910 may traverse a path through the N segments S₁ 931 to S_{N} 936 of the optical channel 930 to reach the optical terminator 940.

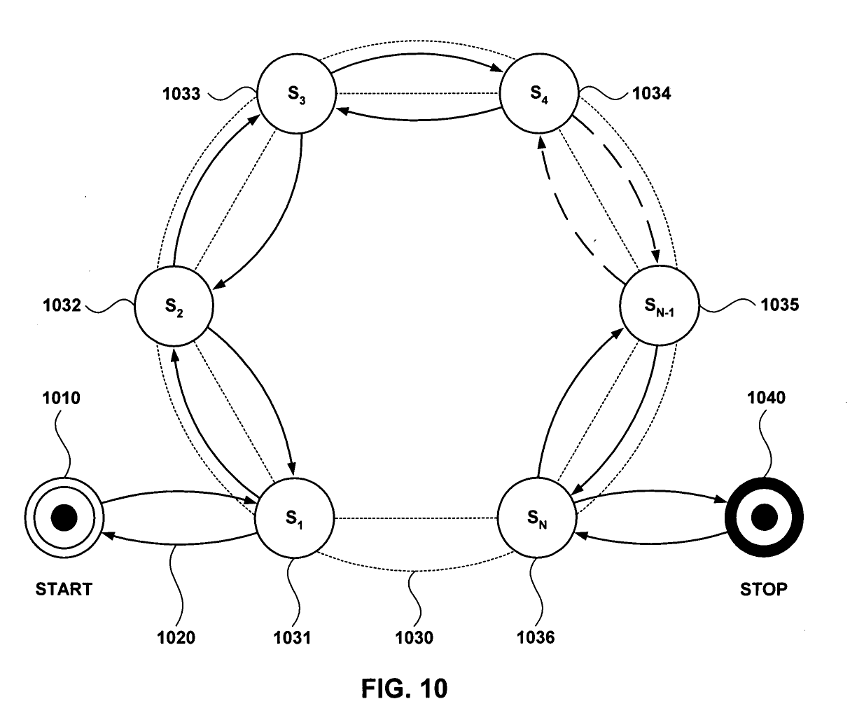

A state model may be used to represent the physical process. FIG. 10 shows an exemplary state model analogous to the physical process. The state model may include a signal source 1010, analogous to the light source 910, and a signal sink 1040, analogous to the optical terminator 940. The model may further include a ring 1030 of states S₁ 1031 to S_{N} 1036, analogous to the segments S₁ 931 to S_{N} 936 of the optical channel 930, where the S₁ 1031 state is coupled to the signal source 1010 and the S_{N} 1036 state is coupled to the signal sink 1040. A tessic signal path 1020 may couple the signal source 1010, through each of the signal states S₁ 1031 to S_{N} 1036 in turn, to the signal sink 1040.

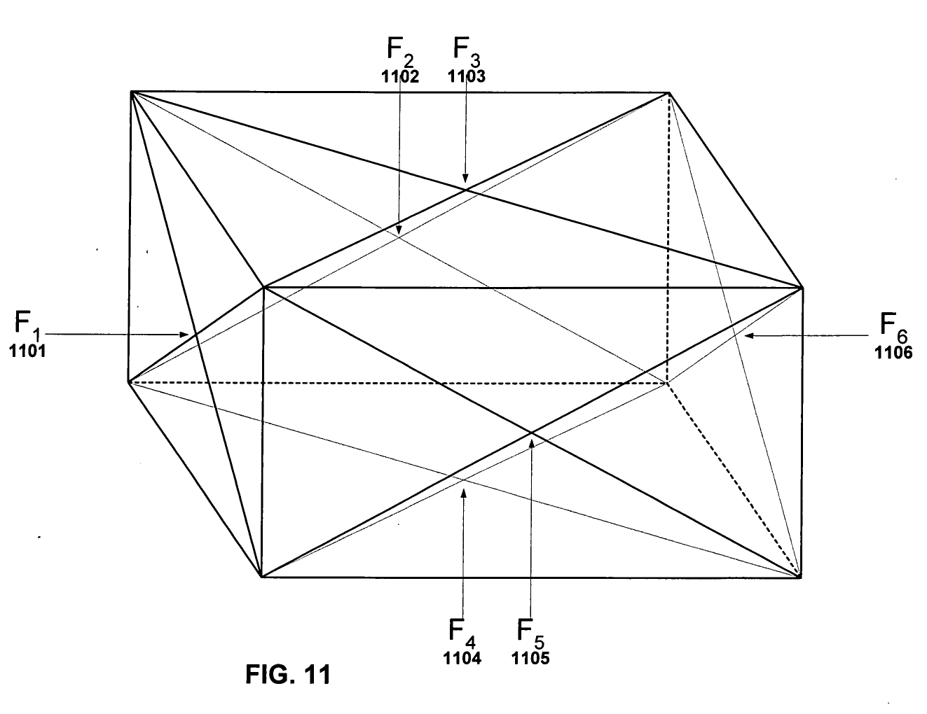

A segment may correspond to the smallest element of a physical process, such as the optical channel 930, that is modeled. Segments are preferably modeled using shapes with fractal properties that facilitate scaling, such as a cube. A cube may be subdivided into additional cubes. Similarly, the triangular optical elements 130 to 183 of FIG. 1 may be grouped into larger triangles. FIG. 11 shows an exemplary cube representing a physical segment of the optical channel 930. The segment may be represented by a cube having six faces F₁ 1101 to F₆ 1106. Face F₁ 1101 is closest to the light source 910 and face F₆ 1106 is closest to the signal sink 940. Face F₁ 1101 adjoins faces F₂ 1102 to F₅ 1105 and opposes face F₆ 1106. Face F₂ 1102 adjoins faces F₁ 1101, F₃ 1103, F₄ 1104 and F₆ 1106, and opposes face F₅ 1105. Face F₃ 1103 adjoins faces F₁ 1101, F₂ 1102, F₅ 1105, and F₆ 1106, and opposes face F₄ 1104. Face F₄ 1104 adjoins faces F₁ 1101, F₂ 1102, F₅ 1105, and F₆ 1106, and opposes face F₃ 1103. Face F₅ 1105 adjoins faces F₁ 1101, F₃ 1103, F₄ 1104 and F₆ 1106, and opposes face F₂ 1102. Face F₆ 1106 adjoins faces F₂ 1102 to F₅ 1105 and opposes F₁ 1101.

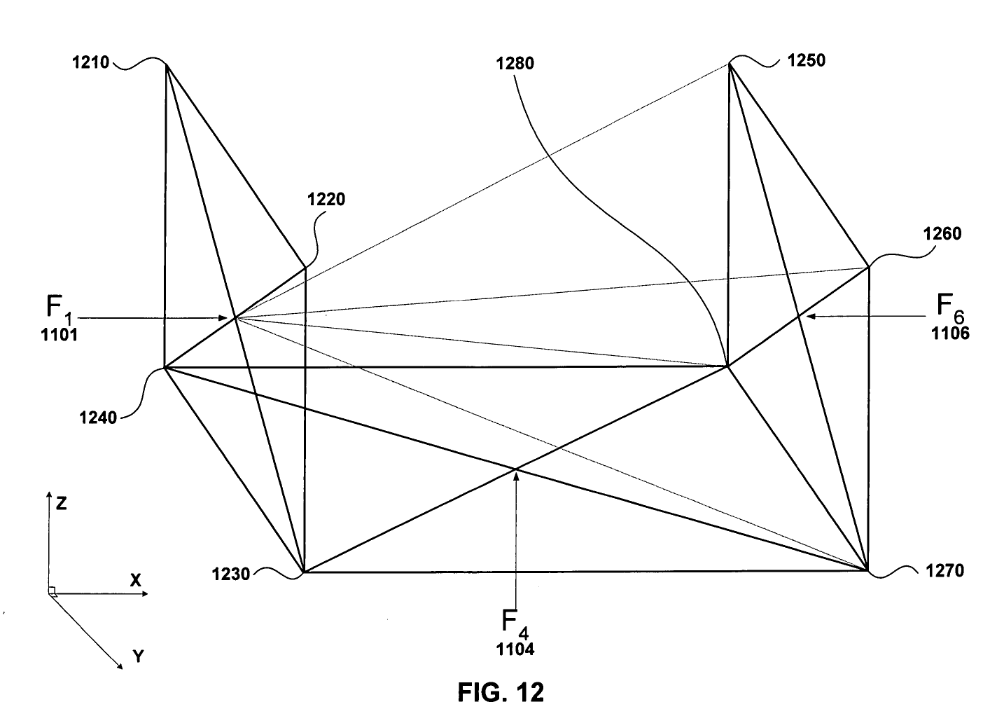

The probability associated with a particular tessic path is partially a function of the geometry of each segment. FIG. 12 shows a cut-away drawing of a segment of the optical channel 930. Three of the faces (F₂ 1102, F₃ 1103 and F₅ 1105) have been removed to better illustrate the geometry between faces F₁ 1101, F₄ 1104 and F₆ 1106. When a photon enters the segment through face F₁ 1101, its momentum may carry it until it coincides with another face F₂ 1102 to F₆ 1106. The reference origin is defined as the geometric center of face F₁ 1101 and the variable x is used to represent the length of each side of the cube. FIG. 12 shows line segments radiating from the geometric center of face F₁ 1101 to each vertex (1250 through 1280) of the opposing face F₆ 1106.

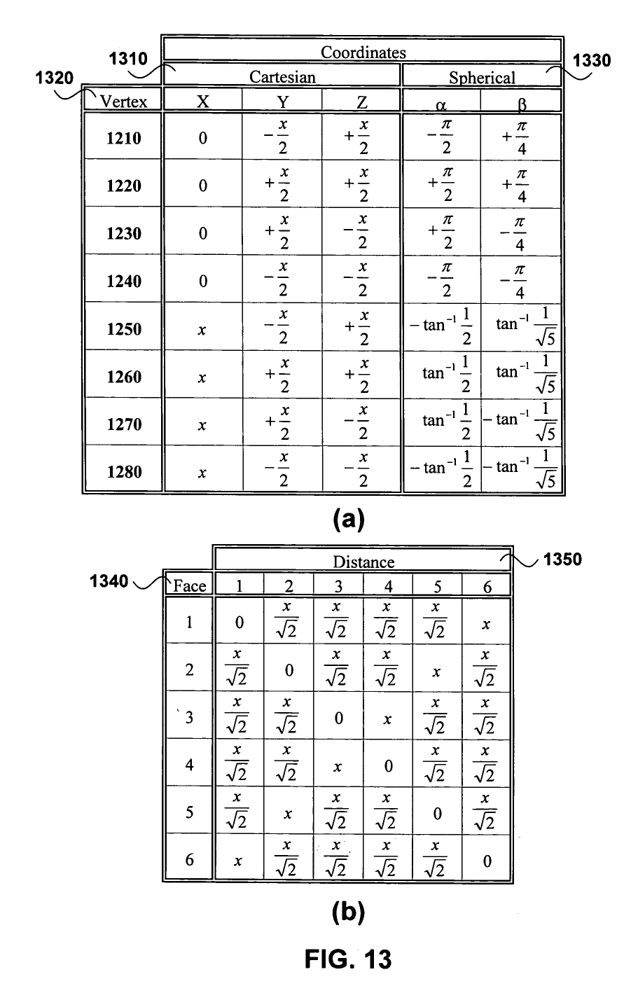

The cube has eight vertices 1210 through 1280, as shown in FIG. 12. Differential Cartesian coordinates 1310 for each vertex 1320 of the cube may be determined using differential geometry, as shown in FIG. 13(a). Next, by defining α as the azimuth and β as the elevation, the spherical coordinates 1330 from the geometric center of face F₁ 1101 to each vertex 1320 may be calculated from the differential Cartesian coordinates 1310. Similarly, distances (Δd) 1350 between geometric centers of respective faces 1340 of the cube may be calculated from the differential Cartesian coordinates 1310 for each vertex 1320, as shown in FIG. 13(b). When an element has fractal properties, the dimensions of the element scale linearly both in the spatial dimensions and the temporal dimension, i.e., the time (Δt) required for a photon to propagate between geometric centers of respective faces, as computed using the equation:

Δt=Δd/c′(λ),

where c′(λ) is the speed of the photonic signal in the material of the optical matrix 105 at the wavelength λ of the photonic signal, and Δd 1350 is the distance between geometric centers of respective faces 1340 of the cube.

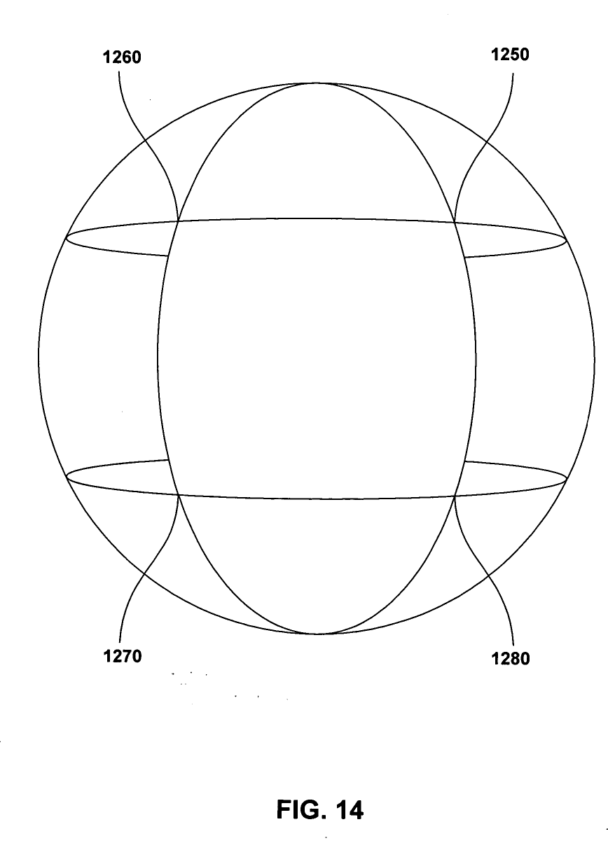

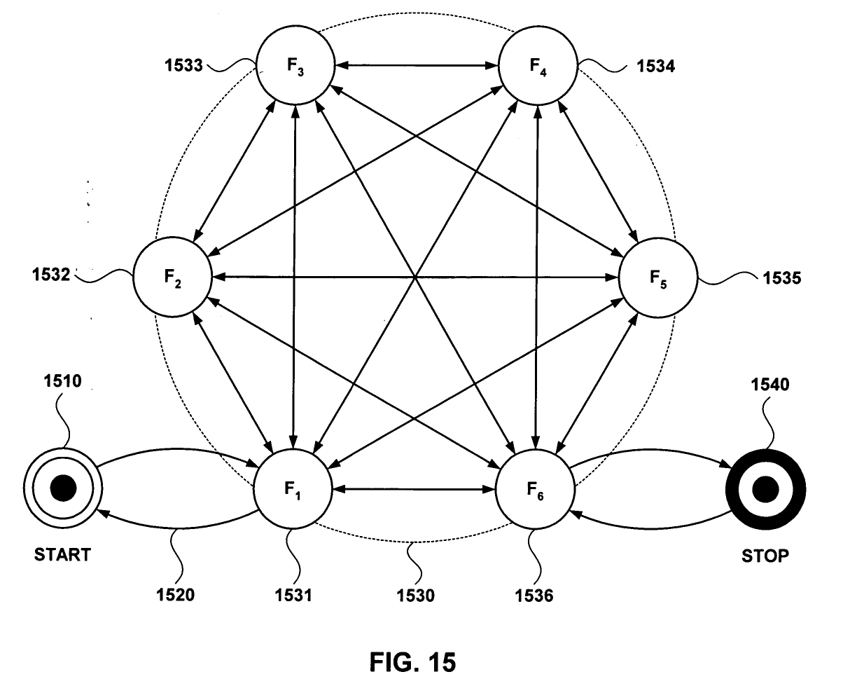

The probability that a photon will intersect a face F₁ 1101 to F₆ 1106 of the cube is a function of the angles to the vertices 1210 through 1280 of the cube viewed from the location of the photon. When a photon is emitted from the light source 910, it may enter the first segment S₁ 931 through face F₁ 1101. The probability that the photon will intersect a particular face of the cube is a function of the angles to the face of the cube, as viewed from the location of the photon. FIG. 14 shows the cube superimposed upon a sphere with the geometric center of face F₁ 1101 at the center of the sphere and vertices 1250 through 1280 of the cube tangent to the surface of the sphere. The vertices of face F₆ 1106 (1250 through 1280) of the cube define a spheric section. The photon may be modeled as having energy with a uniformly distributed angular orientation; i.e., an isotropic radiation pattern. Each element of the optical matrix 105 may be modeled using coupled-dipole antennas having an effective linear dimension less than the wavelength of an electromagnetic wave of interest. The coupled-dipole antenna model may be consistent with physical reality to dimensions as small as an atomic radius because all chemically stable compounds have an even number of electrons, corresponding to the coupled-dipole antennas. Deviations from an isotropic radiation pattern may be modeled using transition probabilities, which correspond to the observed flux density of an electromagnetic wave radiated from an antenna.

The probability that the photon will intersect a face F₂ 1102 to F₆ 1106 of the cube is proportional to the ratio of the surface area of the spheric section to the surface area of the sphere and may be calculated using the equation:

$${p}_{i} ∝ \frac{{\int }_{{α}_{1}}^{{α}_{2}} {\int }_{{β}_{1}}^{{β}_{2}} cos β \cdot ⅆ β \cdot ⅆ α}{4 π} , i = 2 … 6$$

The probability that the photon will intersect face F₆ 1106 of the cube may be calculated using the equation:

$${p}_{i} ∝ \frac{\vert α \cdot sin β \vert}{π} , i = 6$$

The probability that the photon will intersect one of the adjoining faces F₂ 1102 to F₅ 1105 of the cube may be calculated using the equation:

$${p}_{i} ∝ \frac{π - \vert α \cdot sin β \vert}{4 π} , i = 2 … 5$$

The probabilities are proportional to the ratios of surface areas when there is a finite probability that the photon may be absorbed and emitted at a later time.

When the material of the optical channel 930 has phosphorescent or fluorescent properties, the physical system may store photons for relatively long periods of time. Phosphorescent materials may trap a photon for longer than 1.0×10⁻⁸ seconds before emitting the photon with an isotropic dispersion. Fluorescent materials may absorb a photon at one frequency and hold the photon for longer than 1.0×10⁻⁸ seconds before emitting a photon at a different frequency with an isotropic dispersion. A time delay in excess of 1.0×10⁻⁸ seconds between the time the photon is absorbed and the time the photon is emitted is significant because a photon may otherwise travel approximately 3.0 meters in a period of 1.0×10⁻⁸ seconds, as computed using the equation:

Δd=Δt·c′(λ),

where c′(λ) is the speed of the photonic signal in the material of the optical matrix 105 at the wavelength λ of the photonic signal. Materials having phosphorescent or fluorescent properties may be represented by assigning a non-zero probability to the tessic path from face F₁ 1101 back to itself. That is,

pᵢ>0, i=1

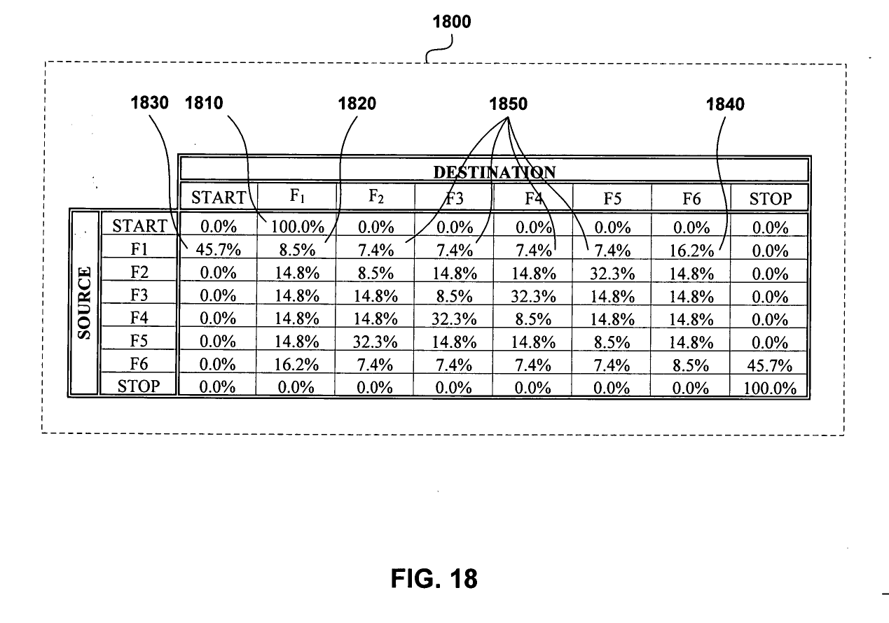

FIG. 18 shows an exemplary tessic transition matrix 1800 for the cube. The first row of the transition matrix 1800 shows a probability 1810 that a photon from the light source 1510 will intersect face F₁ 1101 of the cube is set to 100%. The second row of the transition matrix 1800 shows a probability 1820 of 8.5% that a photon will be absorbed by face F₁ 1101 to be emitted at a later time. The probability 1820 that the photon will be absorbed is actually a function of the phosphorescent or fluorescent properties of the material used to construct the optical matrix 105 and may be set accordingly. The probability 1830 that the photon will exit face F₁ 1101 and reflect toward the light source 1510 is set at 45.7%, corresponding to half of the probability that the photon is not trapped by an electron. The probability 1840 that the photon will intersect face F₆ 1106 is approximately 35.4% of the remaining probability, i.e. 16.2%. The probability 1850 that the photon will intersect one of the other faces F₂ 1102 to F₅ 1105 may be computed by dividing the remaining probability into four equal parts, i.e. 7.4%. The process is repeated to complete the remaining rows of the transition matrix 1800.

A tessic tracing method may be used to model the path a photon traverses through a segment. FIG. 15 shows an exemplary state model representative of the photon transfer process within a segment, representative of the present invention. The segment model may include a signal source 1510, analogous to the light source 910 and a signal sink 1540, analogous to the optical terminator 940. The model may further include a ring 1530 of states F₁ 1531 to F₆ 1536, where the F₁ 1531 state is coupled to the signal source 1510 and the F₆ 1536 state is coupled to the signal sink 1540. Each state F₁ 1531 to F₆ 1536 is coupled to every other state with paths. For example, a photon at state F₂ 1532 may traverse a tessic path to any one of states F₁ 1531 and F₃ 1533 to F₆ 1536. Additionally, each state is coupled to itself with a tessic path; for example, there is a path from state F₂ 1532 back to the same state F₂ 1532. This path represents the possibility that a photon will remain within face F₂ 1102 due to luminescence or fluorescence. A tessic signal path 1520 may couple the signal source 1510 through each of the signal states F₁ 1531 to F₆ 1536 in turn, to the signal sink 1540.

In general, photon transfer processes are chaotic and highly non-linear. When the light source 910 is activated, photons may propagate through the optical channel 930 to the optical terminator 940. Some photons may reflect from face F₁ 1101 of segment S₁ 931 and face F₆ 1106 of segment S_{N} 936. Photons may be absorbed by electrons and then emitted later, delaying the photons as they traverse the optical channel 930. If the light-source 910 emits a photonic signal with a constant power envelope, the optical flux density within the optical channel 930 will converge to a steady state response.

By definition, at steady-state the expected value of the number of photons entering the optical channel 930 is in equilibrium with the number of photons exiting the optical channel 930 over one period of the photonic signal. The number of photons expected to enter and to exit the optical channel 930 are exactly equal, therefore the optical flux density is constant. Non-linear distortion effects, such as passive intermodulation, are caused by amplitude-modulation to amplitude-modulation effects and amplitude-modulation to phase-modulation effects. When the optical flux density is constant, the amplitude of the photonic signal is constant as well. Thus, at steady-state any nonlinearities in the optical channel 930 will not produce non-linear distortion effects that distort the photonic signal and the solution to the non-linear process converges to the same result as a representative linear process. Consequently, at steady-state the tessic transition matrix 1800 may be used as a transition matrix for a Markov process that represents the optical channel 930. The Markov process may then be solved to determine the channel response using linear algebra methods, such as those taught in the paper “The Mean Power Spectral Density of Markov Chain Driven Signals” by P. Galko and S. Pasupathy, IEEE Trans. on Info. Theory, November 1981, pp. 746-54; the paper is incorporated herein by reference.

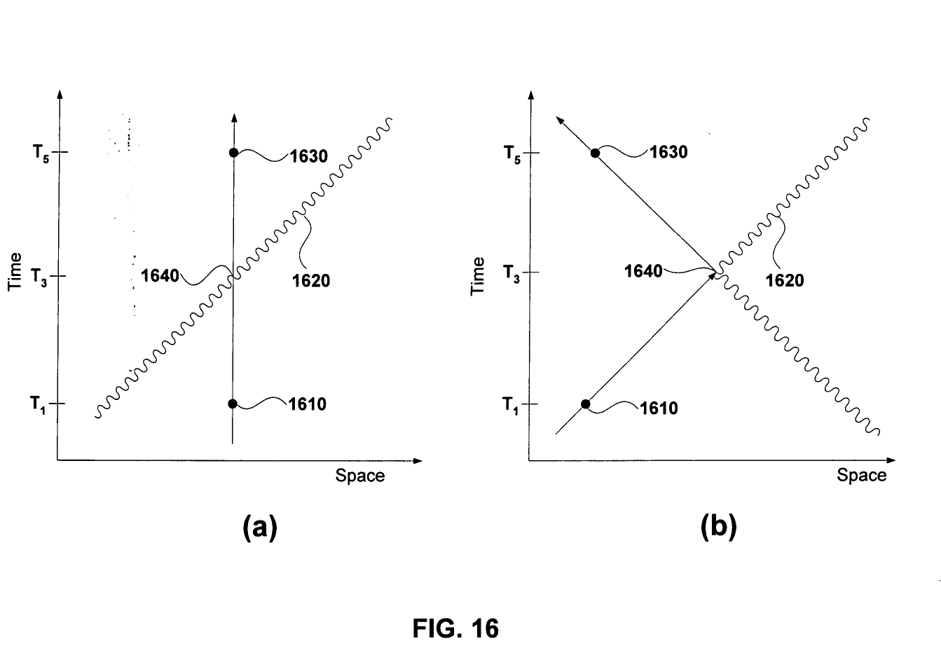

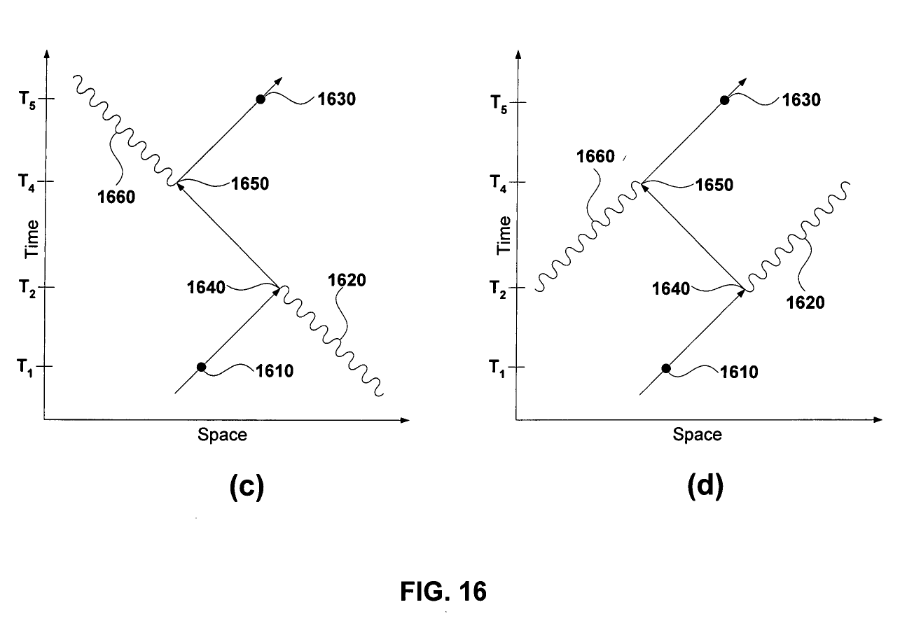

The tessic path-tracing system may also incorporate logic regarding the many different ways that real photons may interact with electrons to produce significant optical interference and scattering effects such as diffraction, polarization, refraction and reflection. FIG. 16 shows four exemplary Feynman diagrams representing interactions between photons and electrons. First, a photon may coincide with the electron without being affected. In FIG. 16(a), an electron has position 1610 at time T₁. A photon 1620 intersects the path of the electron at position 1640 and time T₃, but neither the photon 1620 nor the electron is affected. The momentum of the electron carries it to position 1630 at time T₅.

Second, a photon may coincide with the electron and be reflected. In FIG. 16(b), an electron has position 1610 at time T₁. A photon 1620 intersects the path of the electron at position 1640 and time T₃, and the photon 1620 and the electron are reflected. The momentum of the electron carries it to position 1630 at time T₅.

Third, the electron may absorb a photon and emit the photon at a later time. In FIG. 16(c), an electron has position 1610 at time T₁. A photon 1620 intersects the path of the electron at position 1640 and time T₂, and the photon 1620 is absorbed by the electron, altering the electron's momentum. At position 1650 and time T₄, the electron emits a photon 1660, again altering the electron's momentum. The emitted photon 1660 is not necessarily the same photon 1620 that was absorbed. The momentum of the electron carries it to position 1630 at time T₅.

Fourth, the electron may emit a photon and then absorb a photon at a later time. In FIG. 16(d), an electron has position 1610 at time T₁. At position 1640 and time T₂, the electron emits a photon 1620, altering the electron's momentum. A photon 1660 intersects the path of the electron at position 1660 and time T₄, and the photon 1660 is absorbed by the electron, altering the electron's momentum. A virtual photon is a photon emitted at a time T₂ earlier than the time T₄ when it was absorbed. The momentum of the electron carries it to position 1630 at time T₅.

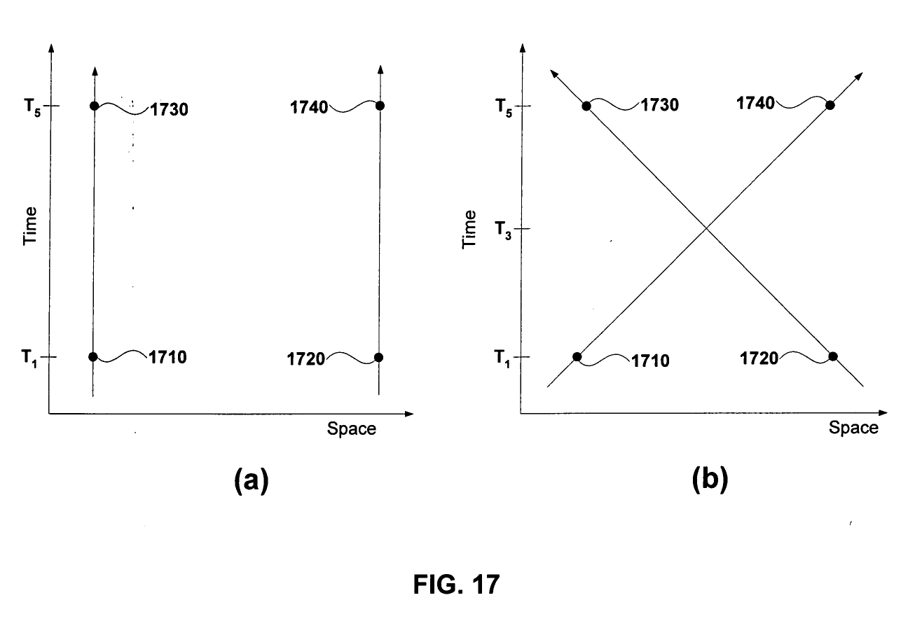

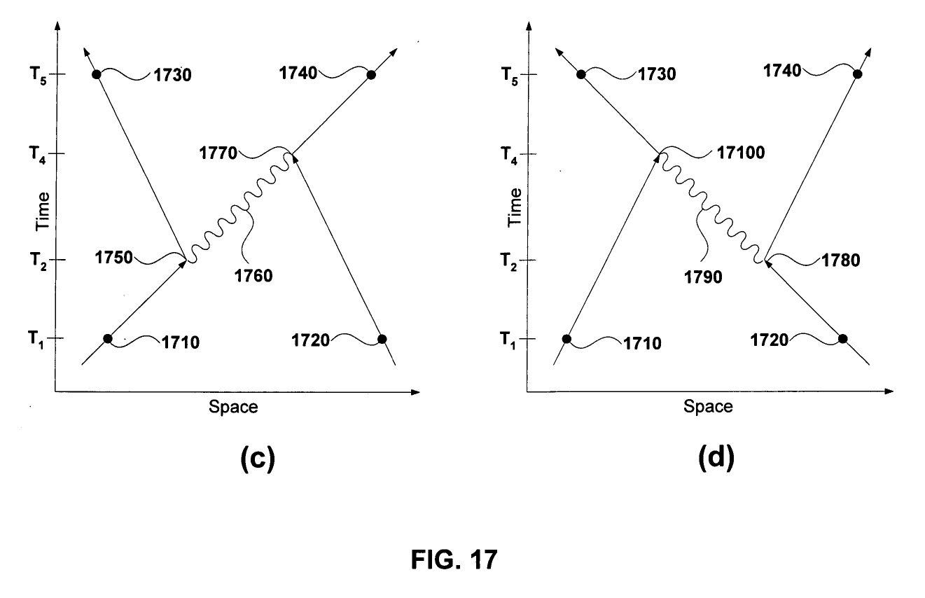

In addition to photon-electron interactions, there are many possible paths that may carry an electron from the same initial position to the same final position. FIG. 17 shows exemplary Feynman diagrams in which two electrons start from the same locations 1710 and 1720 in space at time T₁. From there, the electrons take different paths that nevertheless end at the same locations 1730 and 1740 in space at time T₅. The paths of the electrons are illustrated as a function of space and time, where the horizontal axis represents displacement in space and the vertical axis represents displacement in time.

The first panel shows a scenario in which the electrons do not move relative to each other and remain in the same position because no event occurs to cause the electrons to move. In FIG. 17(a), the two electrons have positions 1710 and 1720 at time T₁. No event occurs to alter the position or momentum of the electrons; thus, the two electrons retain positions 1730 and 1740 at time T₅.

The second panel shows a scenario in which the electrons move relative to each other and the momentum of the electrons causes them to exchange positions. In FIG. 17(b), the two electrons have positions 1710 and 1720 at time T₁. The electrons have momentum carrying them toward positions 1730 and 1740. As shown, the tessic paths may intersect at position 1725 and time T₃. However, the drawing is a 2-dimensional representation of a 4-dimensional path and the electrons may or may not coincide at position 1725 and time T₃. If the electrons do not coincide, then the momentum of the electrons may be unaffected. That is, one electron may start at position 1710 at time T₁ and its momentum may carry it to position 1740 at time T₅. The other electron may start at position 1720 at time T₁ and its momentum may carry it to position 1730 at time T₅.

If the electrons do coincide, then they may reflect off of each other. That is, the electrons may have positions 1710 and 1720 at time T₁. At position 1725 and time T₃, the electrons may repel each other, changing the momentum of both electrons. The first electron may start at position 1710 at time T₁ and reflect away from the second electron at position 1725 and time T3. Then the first electron's momentum may carry it to position 1730 at time T₅. Similarly, the second electron may start at position 1720 at time T₁ and reflect away from the first electron at position 1725 and time T₃. Then the second electron's momentum may carry it to position 1740 at time T₅. Thus, whether or not the electrons coincide at position 1725 and time T₃, the tessic paths may start at positions 1710 and 1720 at time T₁ and end at positions 1730 and 1740 at time T₅.

The third panel shows a scenario in which the electrons exchange a photon. In FIG. 17(c), the two electrons have positions 1710 and 1720 at time T₁. The electrons have momentum that carries them toward positions 1730 and 1740. At time T₂, one of the electrons emits a photon 1760 and changes trajectory toward position 1730. At time T₄, the other electron absorbs the photon 1760 and changes trajectory toward position 1740. The new trajectories of the electrons carry them to positions 1730 and 1740 at time T₅.

The fourth panel shows a scenario in which the electrons exchange a virtual photon. In FIG. 17(d), the two electrons have positions 1710 and 1720 at time T₁. The electrons also have momentum carrying them toward positions 1730 and 1740. At time T₂, one of the electrons absorbs a photon 1790 and changes trajectory toward position 1740. At lime T₄, one of the electrons emits the photon 1790 and changes trajectory toward position 1730. The new trajectories of the electrons carry them to positions 1730 and 1740 at time T₅. In this scenario, the virtual photon is absorbed before it is emitted and therefore appears to move backwards through time. A virtual photon scenario may occur when an electron captures a photon in one simulation frame, then releases the photon and captures another photon within a later simulation frame. Consequently, the tessic path of FIG. 17(d) is possible, as is permitted by the tessic tracing method.

Many possible photon-electron interactions may produce indistinguishable outcomes, as noted by Richard Feynman in QED: The Strange Theory of Light and Matter, p. 115-19 (1985). Consequently, a tessic path-tracing system may model interactions of photons and electrons using probabilistic operators, such as the expected value operator. When used in combination with efficient scaling techniques, such as fractals, the tessic-path tracing system may allow efficient modeling, simulation, analysis and design of chaotic and quasi-random systems.

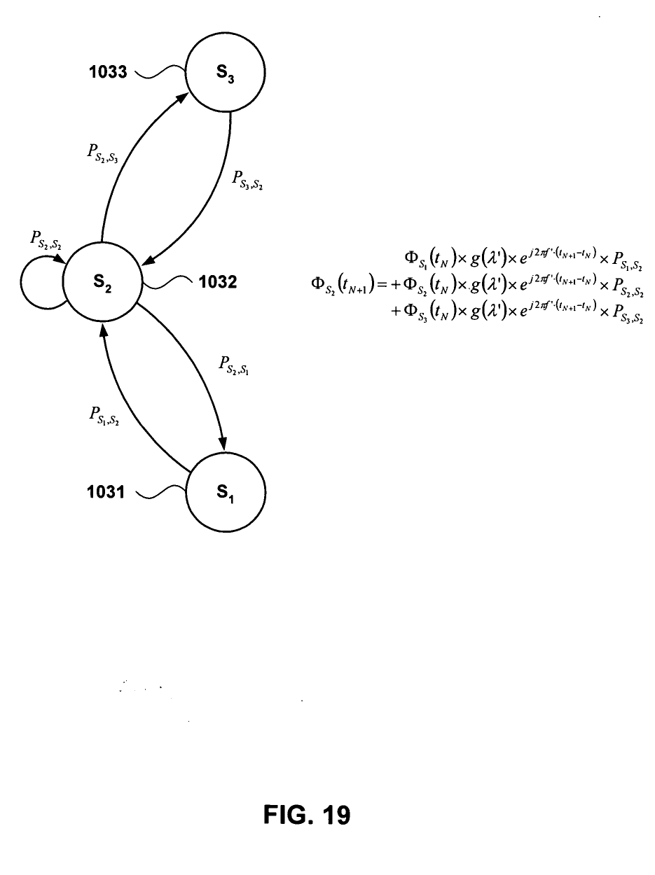

FIG. 19 shows a method for determining an optical signal at a segment corresponding to the exemplary physical system shown in FIG. 9 and the exemplary state model shown in FIG. 10. FIG. 9 shows that the signal path 920 from physical segment S₁ 931 to physical segment S₃ 933 traverses physical segment S₂ 932. Similarly, FIG. 10 shows that the tessic path 1020 from the S₁ 1031 state to the S₃ 1033 state is coupled through the S₂ 1032 state. Therefore, the optical signal at a segment may be determined by combining the contribution of the two adjacent segments to the signal “stored” in the segment. As shown in FIG. 19, the optical signal observable at a segment at any moment in time may be determined from the previous observed states, a scaling factor determined by properties of the material comprising the optical matrix and the geometry of the tessic signal path 1020, and the probability values from the transition matrix. Thus, the steady-state optical signal observable at each segment may be determined using a Markov process.

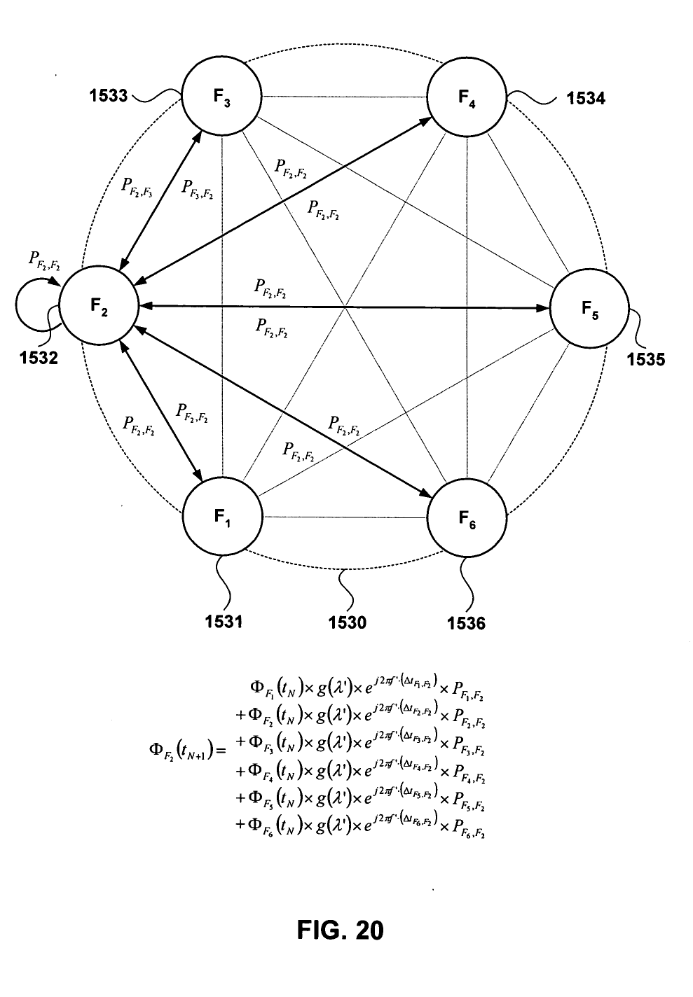

Similarly, FIG. 20 shows a method for determining an optical signal at a face of the segment corresponding to the physical segment shown in FIG. 11 and the exemplary state model shown in FIG. 15. FIG. 15 shows that the tessic signal path 1520 couples each face of the physical segment to every other face of the physical segment. Therefore, the optical signal at a face of the segment may be determined by combining the contribution of each adjacent face of the segment to the signal “stored” in the face. As shown in FIG. 20, the optical signal observable at a face of the segment at any moment in time may be determined from the previous observed states, a scaling factor determined by properties of the material comprising the optical matrix and the geometry of the tessic signal path, and the probability values from the transition matrix. Thus, the steady-state optical signal observable at each segment may also be determined using a Markov process. Therefore, the response of physical system 930 may be determined using nested Markov processes, wherein at least one Markov process corresponds to interactions of optical signals within a segment, and at least one Markov process corresponds to interactions of optical signals between segments. Moreover, the development of complex optical devices may be further facilitated by partitioning the design problem into functional segments.

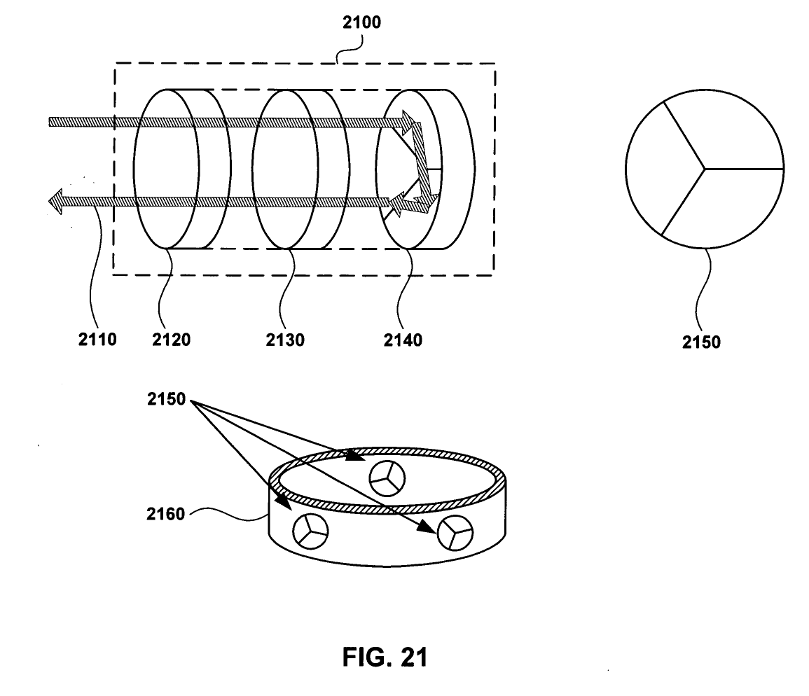

For example, FIG. 21 shows an exemplary optical device 2100 configured to provide cooperative battlefield identification of friendly forces. Optical device 2100 may receive an optical signal 2110 from a combatant, process the signal to determine whether or not to respond, and if appropriate transmit a response to the position of the combatant, without transmitting a radio signal that may be detected by enemy forces. Optical device 2100 may include, for example, a filter 2120 stage so that the device processes only signals at certain optical frequencies or specific polarizations. Such a filter 2120 helps to prevent device 2100 from ‘glinting’ and revealing the target's location when illuminated by a bright flash of light. Filter 2120 may also incorporate an anti-reflective coating to prevent scintillation.

Additionally, device 2100 may include a coding stage 2130 that performs cryptographic operations on the received signal. Coding stage 2130 may comprise a plurality of layers of material. In the alternative, coding stage 2130 may be formed using a single layer of material assembled using a multi-layer deposition process. As noted previously, specific Boolean operations may be performed on the optical signal by controlling the lengths of photonic paths through the layers of material. Additionally, signal processing operations, such as cosine operations, may be performed by controlling the lengths of photonic paths through the layers of material. Consequently, Boolean operations and signal processing operations may be performed simultaneously in the same optical device.

For example, the received signal may be compared to a predetermined pattern using optical logic gates taught in the present invention, and device 2100 may respond if and only if the received signal corresponds to the predetermined pattern. For another example, the received signal may be processed using a optical correlator structure that is configured according to an amplitude modulated code such as a Barker code, or a phased-magnitude code such as the code sequences taught in U.S. Pat. No. 5,283,586, entitled “Method of Phased Magnitude Correlation Using Binary Sequence” by Pender et al.

For yet another example, device 2100 may receive an optical signal containing information, such as a phase-modulated signal, encrypt the received signal according to a predetermined cryptographic algorithm and key, and then transmit the encrypted signal to the point of origin of the transmission. Methods for encrypting a signal according to a secure cryptographic algorithm such as, for example, an Advanced Encryption Standard (AES) protocol, a Data Encryption Standard (DES) protocol, a Digital Signature Standard (DSS) protocol, a triple-DES protocol, an RSA™ protocol, or a Key Exchange Algorithm (KEA) protocol may be readily constructed from Boolean logic gates. Thus, device 2100 may receive a coded signal, analyze the information content of the signal and if appropriate, transmit an encrypted response. By examining the response, in view of the transmitted signal, the combatant may determine whether the targeted troops are friendly. Moreover, because the combatant may dynamically change the information encoded in the transmitted signal, hostile troops cannot fake a correct response by capturing and retransmitting old signals.

Furthermore, because the encryption operations may be performed optically, device 2100 may provide the combatant which illuminates the target with a response in real-time, i.e. the time required for the optical signal to traverse the distance from the combatant to the target and return. Additionally, each device 2100 may simultaneously respond to a plurality of interrogation signals that are distributed either in frequency or in position from multiple combatants.

The device may further include a mirror stage 2140. For example, device 2100 may include a flat mirror, or in the alternative, a retroflector mirror. A retroflector mirror may be assembled using three flat mirrors joined at right angles, and then oriented at 45 degrees to the line of sight. Retroflector mirrors are known in the art by various names including, for example, “corner cubes” and “trihedral prisms.” A retroflector mirror reflects incident optical signals along the line of sight back to the origin of the optical signal. Thus, a retroflector mirror may reflect an optical signal, such as the laser beam of a laser targeting system, to the same point in space from which the beam was transmitted.

The functions of the components of device 2100 may be assembled from separate component stages so that one or more stages, such as the filter, may be exchanged. In the alternative, a single, integrated optical device 2150 may be developed using the automated process shown in FIG. 6, by combining the fitness functions corresponding to each stage into a single fitness function for the entire device 2100. Device 2150 is an exemplary embodiment for a front-aspect view of an integrated optical device. A plurality of devices (2100, 2150) may then be integrated into a housing 2160 to receive, process, and respond to optical signals from any angle in a 360 degree circle.

With regard to the methods and apparatuses disclosed herein, terms such as “light”, “photonic signal”, “fiber optic” and “optical matrix” may refer to any electromagnetic wave. The terms are not to be limited to the visible portion of the spectrum; a preferred embodiment for the optical matrix 105 may include photonic signals having frequencies between direct current (0.0 Hz) and X-rays (approximately 5.3×10²⁰ Hz).

What is claimed is:

1. A device for cooperative friend-or-foe target identification comprising:
at least one optical port configured to receive at least one optical signal from a source;
a plurality of optical elements that interact with the received optical signal based on information encoded within said at least one optical signal to selectively radiate a second optical signal.

2. The device of claim 1, further comprising a retroflector mirror configured to radiate the second optical signal toward the source.

3. The device of claim 1, wherein the source is a laser.

4. The device of claim 1, wherein said plurality of optical elements selectively radiate the second optical signal according to a frequency of the received optical signal.

5. The device of claim 1, wherein said plurality of optical elements selectively radiate the second optical signal according to a polarization of the received optical signal.

6. The device of claim 1, wherein said plurality of optical elements selectively radiate the second optical signal according to information encoded in the received optical signal.

7. The device of claim 1, wherein said plurality of optical elements determine the second optical signal by encoding the received optical signal according to a predetermined coding algorithm.

8. The device of claim 1, wherein said plurality of optical elements determines the second optical signal by encrypting the received optical signal according to a predetermined cryptographic algorithm.

9. The device of claim 8, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

10. A device for real-time encryption comprising:
at least one optical port configured to receive at least one optical signal from a source; and
a plurality of optical elements that interact with the received optical signal to determine a second optical signal by encrypting the received optical signal according to a predetermined cryptographic algorithm.

11. The device of claim 10, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

12. A method for cooperative friend-or-foe target identification comprising:
receiving at least one optical signal from a source;
determining, using a plurality of optical elements, whether to radiate a second optical signal based on information encoded within said at least one optical signal; and
selectively radiating the second optical signal based upon the determination.

13. The method of claim 12, further comprising:
determining whether to radiate the second optical signal according to a frequency of the received optical signal.

14. The method of claim 12, further comprising:
determining whether to radiate the second optical signal according to a polarization of the received optical signal.

15. The method of claim 12, further comprising:
determining whether to radiate the second optical signal according to information encoded in the received optical signal.

16. The method of claim 12, further comprising:
encoding the received optical signal according to a predetermined coding algorithm to determine the second optical signal.

17. The method of claim 12, further comprising:
encrypting the received optical signal according to a predetermined cryptographic algorithm to determine the second optical signal.

18. The method of claim 12, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

19. A method for real-time encryption comprising:
receiving at least one optical signal from a source; and
determining a second optical signal, using a plurality of optical elements that encrypt the received optical signal according to a predetermined cryptographic algorithm.

20. The method of claim 19, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

21. A device for cooperative friend-or-foe target identification comprising:
means for receiving at least one optical signal from a source;
means for determining, using a plurality of optical elements, whether to radiate a second optical signal based on information encoded within said at least one optical signal; and
means for selectively radiating the second optical signal based upon the determination.

22. The device of claim 21, further comprising:
means for determining whether to radiate the second optical signal according to a frequency of the received optical signal.

23. The device of claim 21, further comprising:
means for determining whether to radiate the second optical signal according to a polarization of the received optical signal.

24. The device of claim 21, further comprising:
means for determining whether to radiate the second optical signal according to information encoded in the received optical signal.

25. The device of claim 21, further comprising:
means for encoding the received optical signal according to a predetermined coding algorithm to determine the second optical signal.

26. The device of claim 21, further comprising:
means for encrypting the received optical signal according to a predetermined cryptographic algorithm to determine the second optical signal.

27. The device of claim 21, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

28. A device for real-time encryption comprising:
means for receiving at least one optical signal from a source; and
means for determining a second optical signal, using a plurality of optical elements that encrypt the received optical signal according to a predetermined cryptographic algorithm.

29. The device of claim 28, wherein said predetermined cryptographic algorithm is selected from a group consisting of an Advanced Encryption Standard (AES) protocol, a Data Encryption Standard (DES) protocol, a Digital Signature Standard (DSS) protocol, a triple-DES protocol, an RSA™ protocol, and a Key Exchange Algorithm (KEA) protocol.

30. A computer program product comprising:
a computer usable medium having a computer readable program code means embodied in said medium for configuring an optical device to determine, using a plurality of optical elements, whether to radiate a second optical signal based on information encoded within at least one received optical signal and to selectively radiate the second optical signal based upon the determination.

31. A computer program product comprising:
a computer usable medium having a computer readable program code means embodied in said medium for configuring an optical device to determine a second optical signal, using a plurality of optical elements that encrypt a received optical signal according to a predetermined cryptographic algorithm.
